(19) United States
(12) Patent Application Publication
(10) Pub. No.: US 2014/0341691 A1
(43) Pub. Date: Nov. 20, 2014

(54) BONDING APPARATUS HAVING A PLURALITY OF ROTARY TRANSFER ARMS FOR TRANSFERRING ELECTRONIC DEVICES FOR BONDING

(71) Applicants: Kui Kam LAM, Kwai Chung (HK); Yen Hsi TANG, Kwai Chung (HK); Wing Fai LAM, Kwai Chung (HK)

(72) Inventors: Kui Kam LAM, Kwai Chung (HK); Yen Hsi TANG, Kwai Chung (HK); Wing Fai LAM, Kwai Chung (HK)

(21) Appl. No.: 14/271,944

(22) Filed: May 7, 2014

Related U.S. Application Data
(60) Provisional application No. 61/823,044, filed on May 14, 2013.

(51) Int. Cl. B65G 47/04

(52) U.S. Cl. CPC B65G 47/04
USPC 414/749.1

(57) ABSTRACT

Disclosed is a bonding apparatus, comprising: i) a supporting device for supporting a supply of electronic devices; ii) an ejecting device for ejecting an electronic device from the supply of electronic devices; iii) a plurality of delivery devices, each delivery device being for delivering a substrate for bonding the electronic devices thereto; and iv) a plurality of transfer devices, each transfer device having a rotary transfer arm operable to transfer the electronic devices from the supply of electronic devices at one or more pick locations to a respective one of the substrates for bonding thereto, upon the electronic devices being ejected by the ejecting device from the supply of electronic devices at the one or more pick locations. A method of bonding electronic devices to substrates is also disclosed.

### FIELD OF THIS INVENTION

This invention relates to a bonding apparatus, which comprises multiple transfer devices for transferring electronic devices (e.g. semiconductor dies). Such a bonding apparatus is particularly, but not exclusively, applicable for bonding semiconductor dies to lead frames.

### BACKGROUND OF THE INVENTION

FIG. 1 shows a conventional die bonder 100, comprising a single rotary transfer arm 114 that is driven by a rotary bond head 118, a single wafer XY table 126 for supporting a wafer 128 having a supply of semiconductor dies, and a single workholder XY table 122 for supporting a substrate 132 for large area die bonding. After a collet of the rotary transfer arm 114 picks up a semiconductor die from the wafer 128 at a pick location 110 using vacuum, the rotary transfer arm 114 rotates towards the substrate 132 to transfer the semiconductor die to the substrate 132 which has epoxy dispensed thereon. After the semiconductor die has been bonded to the substrate 132, the rotary transfer arm 114 rotates back to the pick location 110 to pick up a next semiconductor die from the wafer 128. This is possible because the wafer XY table 126 is movable to align the next semiconductor die with the pick location 110.

One drawback of the conventional die bonder 100 lies in its sequential operation in picking semiconductor dies from the wafer 128 and placing them onto the substrate 132. Such a sequential operation limits the throughput capacity of the conventional die bonder 100. Thus, it is an object of this invention to seek to ameliorate such a drawback of the conventional die bonder 100.

### SUMMARY OF THE INVENTION

A first aspect of the invention a bonding apparatus, comprising: i) a supporting device for supporting a supply of electronic devices; ii) an ejecting device for ejecting an electronic device from the supply of electronic devices; iii) a plurality of delivery devices, each delivery device being for delivering a substrate for bonding the electronic devices thereto; and iv) a plurality of transfer devices, each transfer device having a rotary transfer arm operable to transfer the electronic devices from the supply of electronic devices at one or more pick locations to a respective one of the substrates for bonding thereto, upon the electronic devices being ejected by the ejecting device from the supply of electronic devices at the one or more pick locations.

A second aspect of the invention is a method of bonding electronic devices to substrates, the method comprising the steps of: a first delivery device delivering a first substrate and a second delivery device delivering a second substrate; an ejecting device ejecting an electronic device from a supply of electronic devices at a first pick location; a first rotary transfer arm transferring the ejected electronic device from the supply of electronic devices at the first pick location to the first substrate for bonding thereto, while a second rotary transfer arm bonds another electronic device that has been transferred from the supply of electronic devices at the first or a second pick location to the second substrate.

### BRIEF DESCRIPTION OF THE DRAWINGS

Preferred embodiments of the present invention will now be described, by way of example only, with reference to the accompanying drawings, of which:

FIG. 1 shows a conventional die bonder with a single rotary transfer arm;

FIG. 2 is a perspective view of a bonding apparatus comprising two rotary bond heads and a die ejecting device, according to a preferred embodiment of this invention;

FIGS. 3a and 3b show a first configuration of the bonding apparatus of FIG. 2, wherein the two rotary bond heads include pick-point alignment mechanisms;

FIG. 4a-4d show a second configuration of the bonding apparatus of FIG. 2, wherein the die ejecting device includes a motorized system; and

FIG. 5 shows a third configuration of the bonding apparatus of FIG. 2, which defines a common pick location.

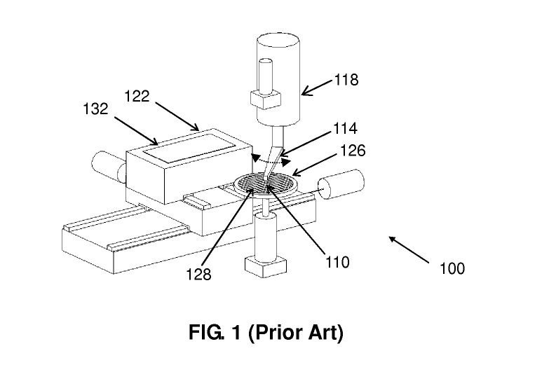

### DETAILED DESCRIPTION OF THE PREFERRED EMBODIMENTS

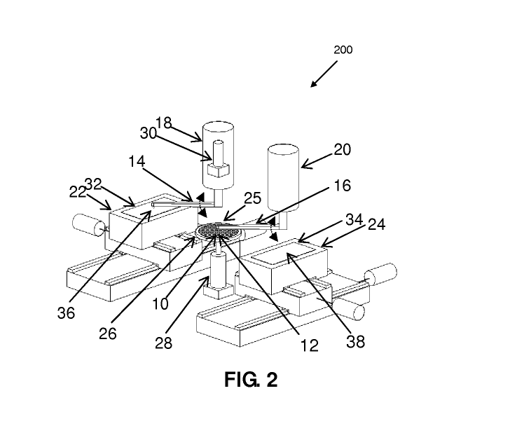

FIG. 2 is a perspective view of a bonding apparatus 200 according to a preferred embodiment of the invention in the form of a dual rotary transfer arm bonding system. The bonding apparatus 200 comprises: i) a single supporting device (shown as a movable wafer XY table 26); ii) a die-supplying device (shown as a wafer 25 that comprises a supply of semiconductor dies) arranged on the wafer XY table 26; iii) an ejecting device (shown as a die ejecting device 28 comprising an ejector pin) for pushing the semiconductor dies of the wafer 25; iv) first and second transfer devices (shown as first and second rotary transfer arms 14 and 16 that are driven by first and second rotary bond heads 18 and 20 respectively); and v) first and second delivery devices (shown as first and second substrate delivering devices 22 and 24) for delivering and supporting substrates 32, 34. Some examples of the substrates 32, 24 include lead frames for die bonding, as well as ball-grid array (BGA) substrates for flip-chip bonding.

The bonding apparatus 200 is configured to operate such that while the first rotary transfer arm 14 bonds a semiconductor die that has been retrieved from the wafer 25 to the substrate 32 at a first bond location 36, the second transfer arm 16 simultaneously picks up another semiconductor die from the wafer 25 at a pick location 12. Thereafter, the second transfer arm 16 rotates towards the second substrate 34 to bond that other semiconductor die thereto at a second bond location 38, while the first transfer arm 14 simultaneously rotates towards the wafer 25 to pick up a next die at a different pick location 10. The motion sequence repeats until the bonding process is completed. Since the pick and place operations of the first and second transfer arms 14 and 16 are performed concurrently, the throughput of the bonding apparatus 200 can be doubled advantageously.

In order to achieve accuracy of the die pick up process, an optics reference point of an optical device (shown as optics 30) is used to align with the pick locations 10, 12, in order to locate the exact positions of the pick locations 10, 12. Similarly, the centre location of the ejector pin of the die ejecting device 28 is also aligned with respect to both the pick locations 10, 12 using the optics 30.

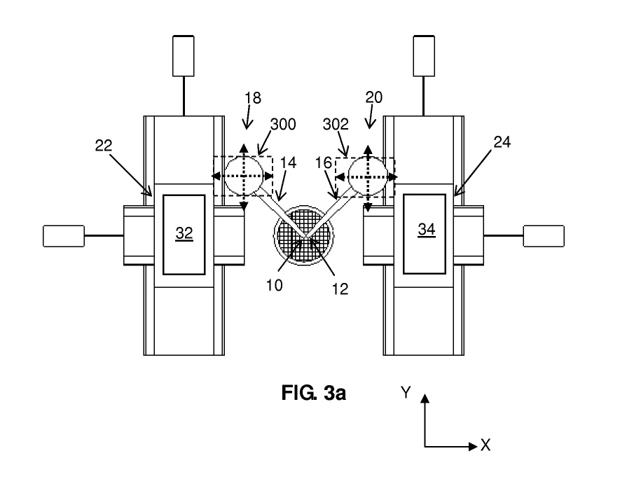

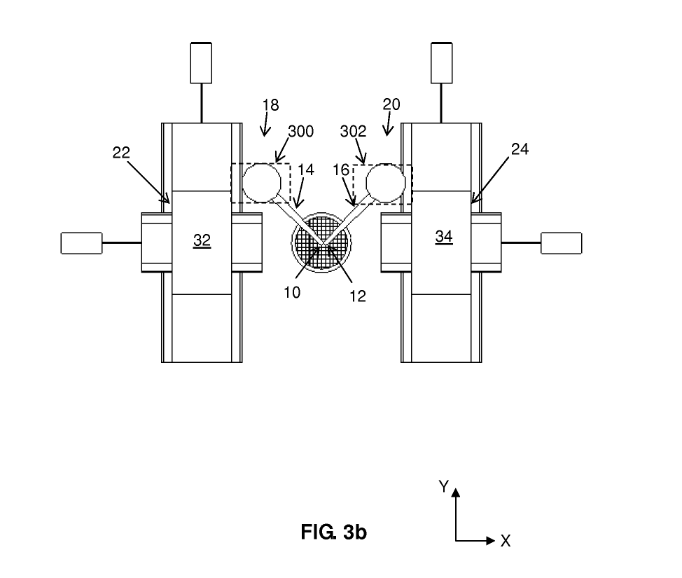

A first configuration of the bonding apparatus 200 is shown in FIGS. 3a and 3b. In particular, the first and second bond heads 18, 20 comprise alignment mechanisms 300, 302 to provide positional adjustment of the transfer arms 14, 16 with respect to the pick locations 10, 12 in x and y directions. Specifically, the alignment mechanisms 300, 302 of the first and second bond heads 18, 20 are configured in order to individually move and align the respective collets of the first and second transfer arms 14, 16 with the respective pick locations 10, 12 using the optics 30. Likewise, the ejector pin center of the die ejecting device 28 can also be aligned with the pick locations 10, 12 using the optics 30. Accordingly, an accurate die pick up process can be achieved advantageously.

It should be appreciated that the wafer XY table 26 is movable to position the wafer 25 with respect to the pick locations 10, 12 and the ejector pin of the die ejecting device 28.

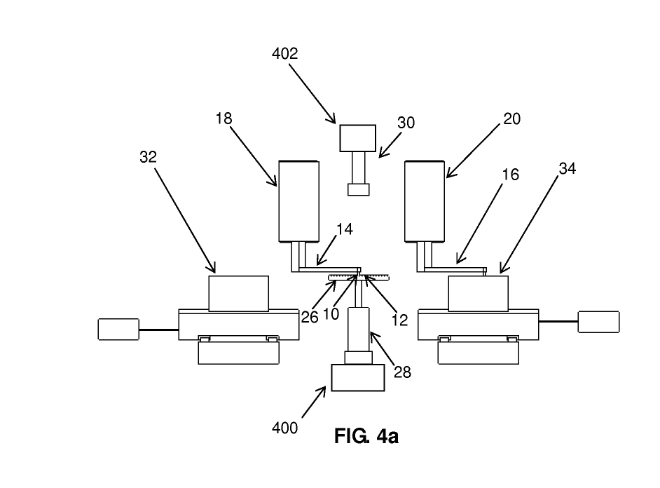

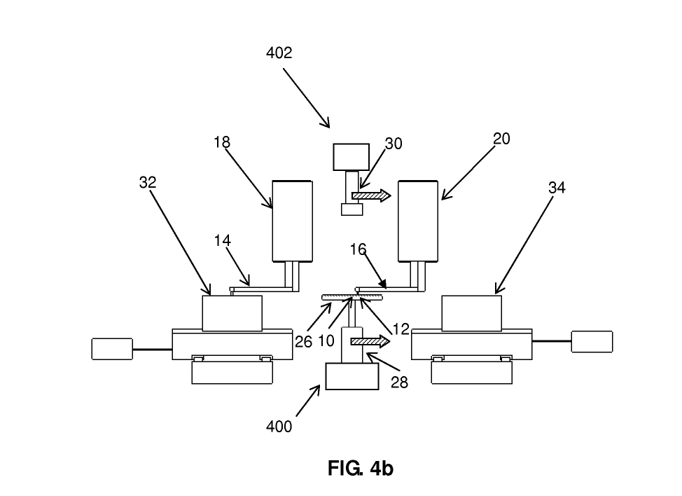

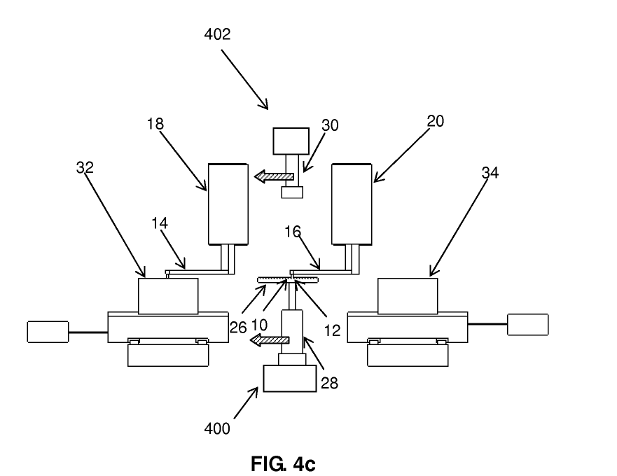

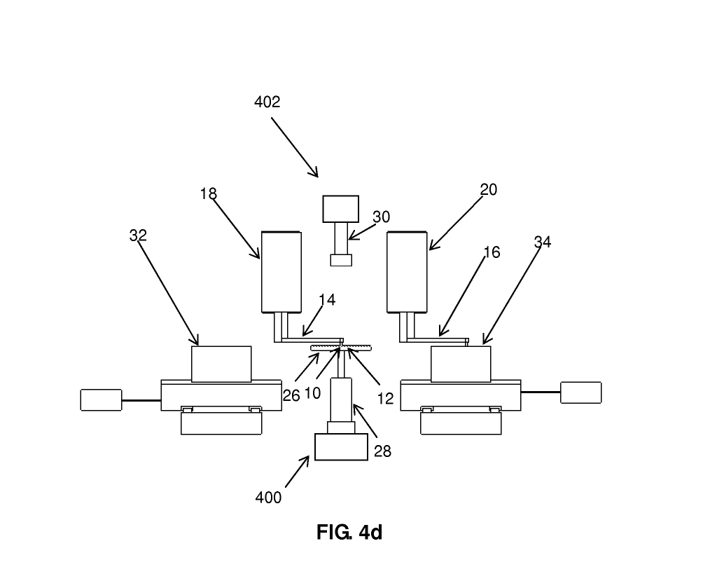

A second configuration of the bonding apparatus 200 is shown in FIGS. 4a-4d. In particular, the ejector pin center of the die ejecting device 28 and the optics reference point of the optics 30 are switched alternately between the pick locations 10, 12. This is achieved by adding a motorized system 400 in the die ejecting device 28. The optics reference point of the optics 30 can be adjusted either by adding another motorized system 402 to the optics 30 or by using a suitably-programmed computer system algorithm.

FIG. 4a shows the ejector pin centre of the die ejecting device 28 and the optics reference point of the optics 30 being aligned with respect to the pick location 10. This allows the first rotary transfer arm 14 to pick up a semiconductor die from the wafer 25 at this pick location 10. Contemporaneously, the second rotary transfer arm 16 bonds a semiconductor die that has been retrieved from the wafer 25 to the second substrate 34.

After the first rotary transfer arm 14 has picked up the semiconductor die from the wafer 25 at the pick location 25, both the die ejecting device 28 and the optics 30 move to align the ejector pin centre and the optics reference point with the other pick location 12 respectively, as shown in FIG. 4b. In particular, the motorized systems 400, 402 move the die ejecting device 28 and the optics 30 respectively to align with the other pick location 12. Thereafter, the second rotary transfer arm 16 rotates towards the wafer 25 to pick up another semiconductor die from the wafer 25 at that other pick location 12. Contemporaneously, the first rotary transfer arm 14 bonds the semiconductor die that has been retrieved from the wafer 25 to the first substrate 32.

Subsequently, the motorized systems 400, 402 move the die ejecting device 28 and the optics 30 respectively to align with the pick location 10, as shown in FIG. 4c, before the first rotary transfer arm 14 rotates towards the wafer 25 to pick up yet another semiconductor die from the wafer 25 at that pick location 10, as shown in FIG. 4d.

Contemporaneously, the second rotary transfer arm 16 bonds the semiconductor die that has been retrieved from the wafer 25 to the second substrate 34.

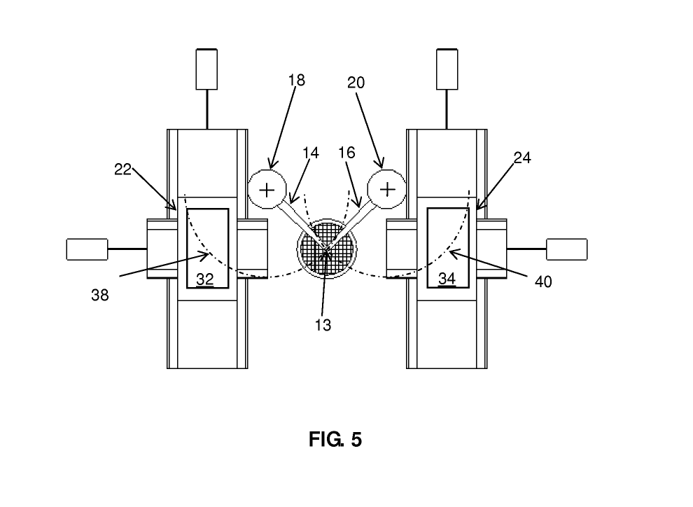

FIG. 5 shows a third configuration of the bonding apparatus 200. In this configuration, the first and second transfer arms 14 and 16 are configured such that motion paths 38, 40 of the first and second transfer arms 14, 16 intersect with each other at a common pick location 13. By aligning the optics reference point and the ejector pin center with respect to this common pick location 13, a good pick up process can be provided without involving the pick-point adjustment mechanisms and/or the motorized systems 400, 402 as described above.

Various embodiments of the invention can also be envisaged within the scope of the invention as claimed.

1. A bonding apparatus, comprising:
a supporting device for supporting a supply of electronic devices;
an ejecting device for ejecting an electronic device from the supply of electronic devices;
a plurality of delivery devices, each delivery device being for delivering a substrate for bonding the electronic devices thereto; and
a plurality of transfer devices, each transfer device having a rotary transfer arm operable to transfer the electronic devices from the supply of electronic devices at one or more pick locations to a respective one of the substrates for bonding thereto, upon the electronic devices being ejected by the ejecting device from the supply of electronic devices at the one or more pick locations.

2. The bonding apparatus of claim 1, wherein the supporting device is arranged between the plurality of delivery devices.

3. The bonding apparatus of claim 1, wherein the plurality of transfer devices comprise a first and a second transfer device having a first and a second rotary transfer arm respectively.

4. The bonding apparatus of claim 3, wherein the first and second rotary transfer arms are configured to pick the electronic devices from the supply of electronic devices at a common pick location, the common pick location being an intersection of respective motion paths of the first and second rotary transfer arms.

5. The bonding apparatus of claim 3, wherein the first and second rotary transfer arms are operable to pick the electronic devices from the supply of electronic devices at different pick locations respectively.

6. The bonding apparatus of claim 5, wherein each of the transfer devices comprises an alignment mechanism for adjusting a position of the rotary transfer arm with respect to the respective pick location.

7. The bonding apparatus of claim 5, further comprising an optical device for determining the different pick locations.

8. The bonding apparatus of claim 7, further comprising a motorized system for moving the optical device between the different pick locations.

9. The bonding apparatus of claim 7, further comprising another motorized system for moving the ejecting device between the different pick locations.

10. A method of bonding electronic devices to substrates, the method comprising the steps of:
a first delivery device delivering a first substrate and a second delivery device delivering a second substrate;
an ejecting device ejecting an electronic device from a supply of electronic devices at a first pick location;
a first rotary transfer arm transferring the ejected electronic device from the supply of electronic devices at the first pick location to the first substrate for bonding thereto, while a second rotary transfer arm bonds another electronic device that has been transferred from the supply of electronic devices at the first or a second pick location to the second substrate.

11. The method of claim 10, wherein the first and second rotary transfer arms are configured to pick the electronic devices from the supply of electronic devices at a common pick location, the common pick location being an intersection of respective motion paths of the first and second rotary transfer arms.

12. The method of claim 10, further comprising the steps of alignment mechanisms adjusting respective positions of the first and second rotary transfer arms with respect to different pick locations.

13. The method of claim 10, further comprising the step of an optical device determining different pick locations.

14. The method of claim 13, further comprising the step of a motorized system moving the optical device between the different pick locations.

15. The method of claim 13, further comprising the step of another motorized system moving the ejecting device between the different pick locations.
